(19) United States
(12) Patent Application Publication
(10) Pub. No.: US 2025/0119199 A1
(43) Pub. Date: Apr. 10, 2025

(54) BEAM SWITCHING MECHANISMS FOR COMMON BEAM MANAGEMENT IN FREQUENCY RANGE 2

(71) Applicant: Apple Inc., Cupertino, CA (US)

(72) Inventors: Jie Cui, San Jose, CA (US); Yang Tang, San Jose, CA (US); Manasa Raghavan, Sunnyvale, CA (US); Qiming Li, Beijing (CN); Xiang Chen, Campbell, CA (US); Huaning Niu, San Jose, CA (US); Dawei Zhang, Saratoga, CA (US); Hong He, San Jose, CA (US)

(21) Appl. No.: 18/729,932

(22) PCT Filed: Feb. 11, 2022
(86) PCT No.: PCT/CN2022/076052

§ 371 Date: Jul. 18, 2024

(51) Int. Cl. H04B 7/08; H04L 5/00

(52) U.S. Cl. CPC H04B 7/088; H04L 5/001

(57) ABSTRACT

Systems, methods, and circuitries are disclosed for avoiding slot decoding failure due to beam switching of a common beam. In one example, a baseband processor for a user equipment (UE) is configured to cause the UE to perform various operations. The operations include receiving a data transmission on a plurality of component carriers (CCs) carrying corresponding symbols on a common beam; receiving a beam switch command from the network node, wherein the beam switch command is configured to cause the UE to switch a receiving (RX) beam at an end boundary of a first symbol of the data transmission; identifying one or more symbols for restricted scheduling in one or more CCs of the plurality of CCs based on the beam switching on the first symbol; and ignoring the one or more symbols identified for restricted scheduling for decoding of the data transmission.

### BACKGROUND

5G NR uses frequency bands in two distinct frequency ranges: Frequency Range 1 (FR1) comprising sub-6 GHz frequency bands, and Frequency Range 2 (FR2) comprising frequency bands above 6 GHZ (e.g., comprising millimeter wave (mmWave), including frequency bands at 24 GHz and above).

While FR1 overlaps with and/or shares some frequency bands employed in other RATs (e.g., Fourth Generation (4G) Long Term Evolution (LTE) bands), FR2 is a unique design feature of 5G NR, which provides multiple advantages, but also presents challenges, such that operation on FR2 is significantly different than operation on FR1. FR2 allows UEs to access a much higher bandwidth, which can be advantageous for services that benefit from a high data rate and/or low latency. However, FR2 suffers from increased pathloss compared to lower frequencies.

### BRIEF DESCRIPTION OF THE DRAWINGS

Some examples of circuits, apparatuses and/or methods will be described in the following by way of example only. In this context, reference will be made to the accompanying figures.

FIGS. 1A-1C illustrate various carrier aggregation schemes.

FIG. 2 illustrates an example dual connectivity and carrier aggregation communication architecture.

FIGS. 3A and 3B are timing diagrams illustrating a carrier aggregated data transmission for intra-band carrier aggregation and inter-band carrier aggregation, respectively.

FIG. 4A is a timing diagram illustrating an inter-band carrier aggregated data transmission and symbols that might be subjected to restricted scheduling, in accordance with various aspects disclosed.

FIG. 4B is a flow diagram of an exemplary method for a UE to receive the data transmission of FIG. 4A.

FIG. 4C is a flow diagram of an exemplary method for a network node to transmit the data transmission of FIG. 4A.

FIG. 5A is a timing diagram illustrating an inter-band carrier aggregated data transmission and symbols that might be subjected to restricted scheduling, in accordance with various aspects disclosed.

FIG. 5B is a flow diagram of an exemplary method for a UE to receive the data transmission of FIG. 5A.

FIG. 5C is a flow diagram of an exemplary method for a network node to transmit the data transmission of FIG. 5A.

FIG. 6A is a timing diagram illustrating an inter-band carrier aggregated data transmission and symbols that might be subjected to restricted scheduling, in accordance with various aspects disclosed.

FIG. 6B is a flow diagram of an exemplary method for a UE to receive the data transmission of FIG. 6A.

FIG. 6C is a flow diagram of an exemplary method for a network node to transmit the data transmission of FIG. 6A.

FIG. 7A is a timing diagram illustrating an inter-band carrier aggregated data transmission and symbols that might be subjected to restricted scheduling, in accordance with various aspects disclosed.

FIG. 7B is a flow diagram of an exemplary method for a UE to receive the data transmission of FIG. 7A.

FIG. 7C is a flow diagram of an exemplary method for a network node to transmit the data transmission of FIG. 7A.

FIG. 8 is a flow diagram of an exemplary method for a UE to perform RX beam switching, in accordance with various aspects disclosed.

FIG. 9 illustrates an example communication network, in accordance with various aspects disclosed.

FIG. 10 illustrates an example of an infrastructure equipment device (e.g., BS, eNB, gNB), in accordance with various aspects disclosed.

FIG. 11 illustrates an example of a user equipment device (referred to herein interchangeably as a “UE” or “UE device”), in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Carrier aggregation (CA) enables multiple different component carriers (CCs) to be simultaneously communicated between a user equipment (UE) and a network node. In some instances, the CCs may be from different permitted frequency domains. Carrier aggregation provides a broader choice to connected devices, enabling more bandwidth to be obtained. The greater bandwidth can be used to communicate bandwidth intensive operations, such as streaming video or communicating large data files.

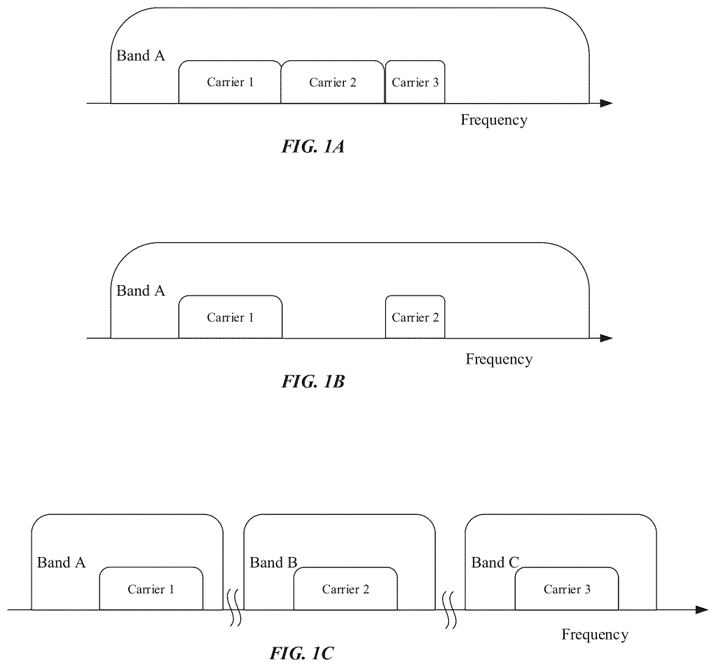

FIG. 1A illustrates an example of intra-band contiguous carrier aggregation. In the example, three CCs are contiguously located within a single frequency band (e.g., frequency band A). The frequency band can be a selected frequency range in the electromagnetic spectrum. Selected frequency bands are designated for use with wireless communication. Certain frequency bands are owned or leased by wireless service providers. Each adjacent CC may have the same bandwidth or a different bandwidth. A bandwidth is a selected portion of a frequency band. Contiguous component carriers may have similar propagation characteristics which can use similar reports and/or processing modules. In other examples (not shown), the contiguous CCs may span two or more frequency bands to provide inter-band contiguous carrier aggregation.

FIGS. 1B and 1C illustrate examples of carrier aggregation of non-contiguous CCs. The non-contiguous CCs are separated in the frequency range. The CCs may be located in different frequency bands. Non-contiguous carrier aggregation can provide aggregation of a fragmented spectrum. Intra-band non-contiguous carrier aggregation provides non-contiguous carrier aggregation within the same frequency band (e.g., band A) as illustrated in FIG. 1B. Inter-band non-contiguous carrier aggregation provides non-contiguous carrier aggregation within different frequency bands (e.g., bands A, B, and C) as illustrated in FIG. 1C. The ability to use CCs in different frequency bands can enable more efficient use of available bandwidth and increase the aggregated data throughput.

In carrier aggregation, each CC is communicated by a different serving cell. A serving cell is a set of communication hardware in a network node that is tuned to transmit/receive in the specific band of a given CC. One of the serving cells is designated as the primary serving cell (PCell) with any other serving cells being designated secondary cells (SCells). The coverage of the different serving cells may differ due to different pathloss for different frequencies. The PCell receives the initial connection request from the UE and carries RRC signaling and other control and user data while the Scellls may carry only data. A handover operation is performed when a UE changes PCells while Scells may be added and dropped as determined by the network without a handover. When carrier aggregation is not in use, the UE is connected only to a PCell.

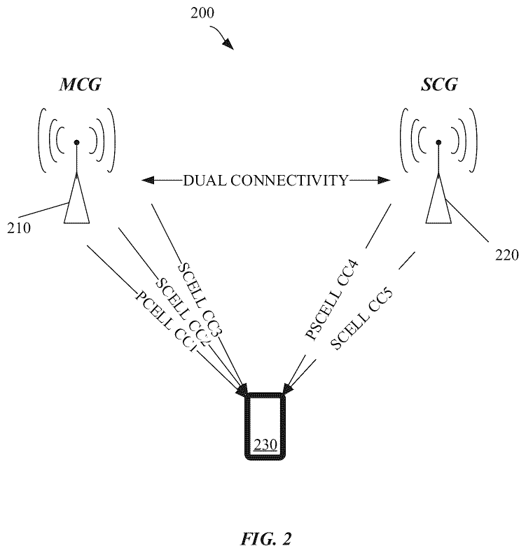

FIG. 2 illustrates a carrier aggregation/dual-connectivity architecture 200. Dual connectivity is a feature that allows a UE 230 to connect with two network nodes (e.g., base stations, transmission/reception points (TRPs), eNBs, gNBs, and so on) 210, 220 simultaneously. The two network nodes may both be operating the same frequency range (e.g., FR1 or FR2) or different frequency ranges. The set of serving cells associated with one of the network nodes 210 is designated the master cell group (MCG) while the set of serving cells associated with the other network node 220 is designated the secondary cell group (SCG). The MCG initiates the dual connection arrangement with the SCG to expand the bandwidth for communication with the UE 230. A portion of the data to be transmitted from the MCG to the UE 230 is transferred to the SCG for transmission to the UE 230.

The MCG includes a primary cell (PCell) and one or more secondary cells (SCells). The PCell is the serving cell with which a UE first initiates a random access channel (RACH) process. In FIG. 2, the serving cell in the MCG carrying CC1 is designated as the PCell and the serving cells carrying CC2 and CC3 are secondary cells. The serving cell in the SCG carrying CC4 is designated as a primary secondary cell (PSCell) and the serving cell carrying CC5 is a secondary cell. The PSCell performs similar tasks as the PCell in the MCG, such as coordinating mobility and communication with the UE and carrying control signaling, but with respect to the SCG.

The CCs in each of the MCG and SCG are combined using carrier aggregation and the UE receives a carrier aggregated data transmission from the MCG and also from the SCG. A dual connectivity (DC) capable UE is able to synchronize and combine the data transmissions from the MCG and the SCG.

When communications between a UE and a network node are beamformed, the various CCs that are aggregated in a carrier aggregation scheme could be transmitted on separate beams. The specific beamforming technique used may be, at least in part, dependent on the frequency bands that carry the CCs. For frequency bands in FR1 beamforming is mainly based on digital-domain precoding techniques. A DL/UL codebook may be used in selecting a preferred precoding matrix from the codebook, which is applied to the signal by baseband processing. In this scenario, beamforming can be efficiently managed by the network node because the precoding occurs in the digital domain before transmission of the signal.

Due to the significant pathlosses in FR2, analog-domain beamforming is typically preferred. In analog-domain beamforming, phase shifters in the transmit/receive chains of the network node and/or UE apply the precoding matrix for a beam. The process of adjusting phase shifters to obtain a new beam is typically slower than the process of changing beams when digital precoding is used. In some systems, a hybrid beamforming technique may be used in which a digital-domain precoding matrix is combined with analog-domain beamforming.

Beam management involves continuous monitoring and reporting of beam strength by the UE. When beam strength sufficiently degrades, the network (or in some instances the UE) may initiate a beam switch process. In 5G, network nodes use a transmission configuration indication (TCI) framework to inform a UE about the node's TX beam options. In general, the TCI includes a source reference signal and an intended quasi co-location (QCL) type. A network node may send downlink control information (DCI) scheduling a physical downlink shared channel (PDSCH) data transmission. To instruct the UE to switch beams, the DCI may indicate a TCI (e.g., beam) to be used for reception of the PDSCH. The UE sets its analog beamforming coefficients based on the indicated TCI. In FR1, different TCI states/beams may be used for different channels. When the UE receives the TCI, the UE takes steps to switch its RX beam to correspond to or best receive the TX beam specified by the TCI. If the network node and UE are communicating on multiple channels (e.g., PDCCH, PUCCH, different CCs in the case of carrier aggregation, and so on), a different TCI state may be indicated for each channel

Providing support for different beams for different channels provides great flexibility. However, the overall signaling overhead caused by such granular beam/channel control may become unnecessarily burdensome. When the communication is taking place in FR2, the network node may utilize one or just a few beams to communicate with a UE. With per-channel beam indication this would mean that many channels/CCs must be separately indicated by the same few TCI states. To address this inefficiency of beam management in FR2, a common beam approach may be taken. In common beam management, the same beam is used for data and control transmission and reception for both downlink and uplink. This means that when carrier aggregation is used, all CCs are transmitted/received on the same beam under common beam management.

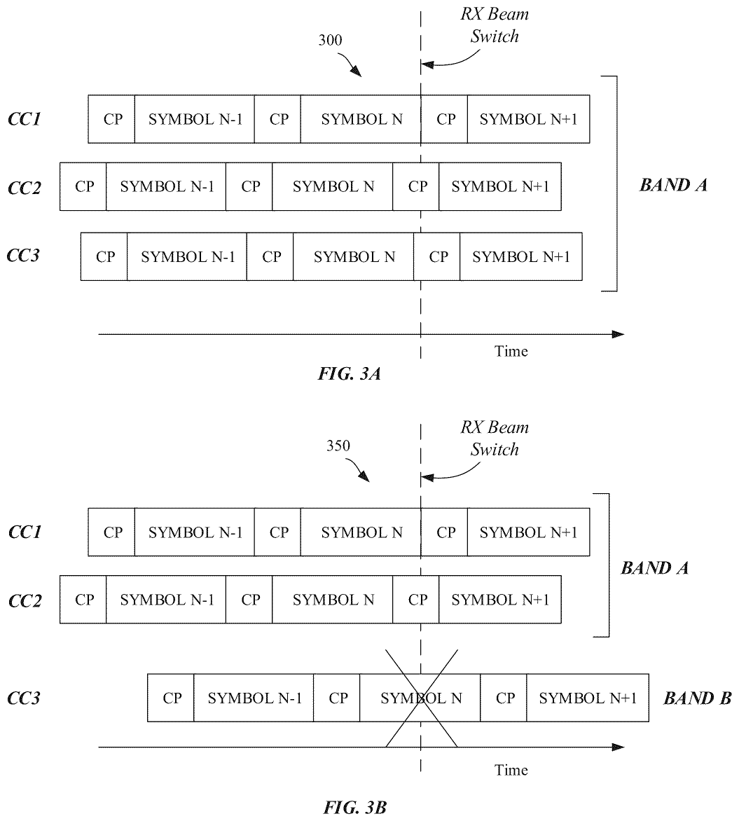

Common beam management for communication in FR2 presents some challenges with respect to inter-band carrier aggregation as illustrated in the comparison of beam switching operations in FIGS. 3A and 3B. FIG. 3A illustrates a data transmission 300 that includes three CCs in intra-band carrier aggregation. When common beam management is used with intra-band carrier aggregation, the pathloss between the different CCs will likely be similar so that the UE should receive corresponding symbols on the different CCs at nearly the same time (e.g., within a cyclic prefix). In other words, in intra-band carrier aggregation symbol level alignment may be assumed. In this case, when a UE switches the RX beam at a given symbol/slot boundary, since the symbols are aligned across the CCs, no interruption of symbol reception in any of the CCs should be experienced by the UE.

FIG. 3B illustrates a data transmission 350 that includes three CCs in inter-band carrier aggregation. Due to form factor limitations and cost constraints, a common beam can be used for all CCs in different bands. Due to the different pathloss characteristics of the non-adjacent CCs and the time misalignment at the network side, the UE may not receive all three corresponding symbols in the CCs with a single CP, including cases where the TX for different CCs are collocated. In other words, in inter-band carrier aggregation symbol level alignment may not be assumed. This means that when a UE switches RX beam at a given symbol/slot boundary, symbols in some of the CCs may be interrupted. As shown in FIG. 3B, symbol N is interrupted in CC3 due to the RX beam switch occurring at the end of symbol N in CC1. The network may not have information about which symbols are interrupted and the UE may fail to receive the entire slot that includes the interrupted signal.

Disclosed herein are systems, circuitries, and techniques for mitigating inter-band carrier data transmission disruption during UE RX beam switching in inter-band carrier aggregation. In the disclosed solutions restrictive scheduling is used to prevent symbols that may be interrupted during a beam switch from encoding data for the UE.

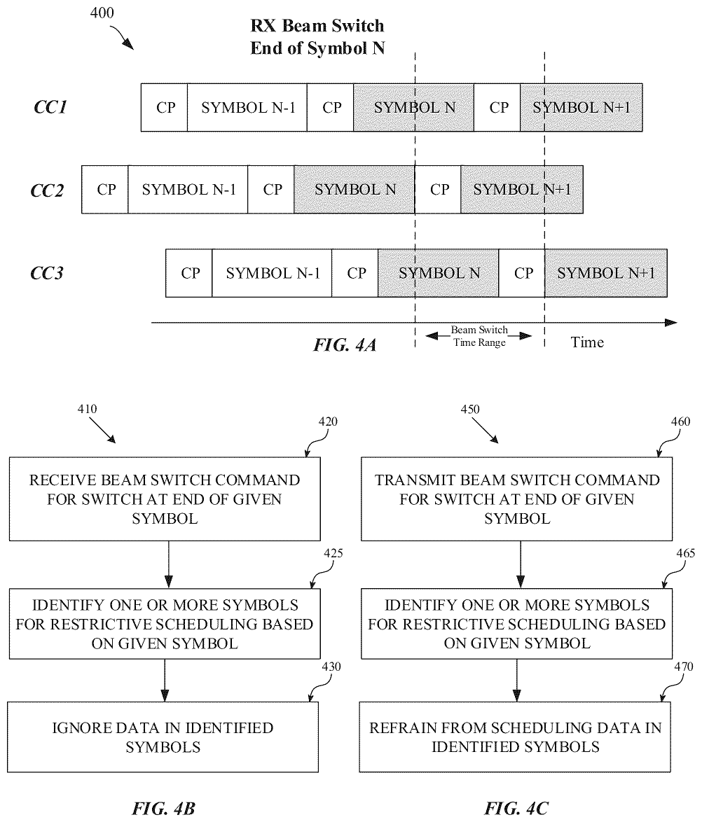

FIG. 4A illustrates a timing diagram depicting potential symbol interruption during RX beam switching that may be caused by UE receive time differences between corresponding symbols carrier by CCs in different frequency bands. The techniques disclosed herein may also be applied to UE RX beam switching when CC symbol or slot alignment within a predetermined threshold, which may be related to CP length, cannot be guaranteed. FIG. 4 depicts a data transmission 400 received from a network node. The data transmission includes corresponding symbols carried on three component carriers in a common beam (e.g., operating in FR2). For example, the three symbols labeled symbol N in the three different CCs are referred to as corresponding symbols. It can be seen that the boundaries of the corresponding symbols on each of the three CCs are not aligned within a threshold (e.g., a CP in FIG. 4A).

The UE may receive a beam switch command that instructs the UE to switch the UE's RX beam. In general, the beam switch command will result in the UE switching RX beam at an end boundary of a predetermined or given symbol, which is referred to and illustrated as symbol N in the following description and examples. In some examples, to synchronize the beam switching of the network node and the UE, the UE beam switch command is performed at a slot boundary of a slot in which the beam switch command is received or a slot boundary of a slot some number of slots after receipt of the beam switch command. When beam switching occurs at a slot boundary, symbol N is the last symbol in the slot such that symbol N's end boundary is a slot boundary. In other examples, beam switching may occur at other symbols within a slot. In some examples, the beam switch command is a TCI switch that indicates a new TX beam for the network node which will in turn cause the UE to select a new RX beam based on the TX beam.

As can be seen in FIG. 4A, the UE will perform the RX beam switch at the end of symbol N in one of the CCs. Depending on which CC carries the symbol N having an end boundary that determines the time of the beam switch, the beam switch can occur within the indicated beam switch time range. The CC that carriers the symbol N that has an end boundary that determines the time of the beam switch will be referred to herein as the reference CC. In some examples, the reference CC is determined during initial connection of the UE to the network node. In some examples, the reference CC is dynamically indicated by control signaling.

In FIG. 4A when CC2 is selected as the reference signal, the symbols corresponding to symbol N in CC1 and CC3 will be received during the RX beam switch and potentially interrupted. When CC3 is selected as the reference signal, the symbols corresponding to the symbol subsequent to symbol N (i.e., symbol N+1) in CC1 and CC2 will be received during the RX beam switch and potentially interrupted. To avoid decoding failure due to interrupted symbols during RX beam switching, one or more symbols are identified for restricted scheduling. A symbol subject to restricted scheduling does not carry data for the UE and as such need not be decoded by the UE. In this manner, rather than risking failure to decode an entire slot due to symbol interruption, symbols that may be subject to interruption are identified for restricted scheduling. The symbols that may be identified for restrictive scheduling may include the symbol N and/or the symbol N+1 (indicated by shading in FIG. 4A) in one or more of the CCs as will be described in more detail below.

FIG. 4B is a flow diagram outlining an example method 410 that may be performed by a UE to receive a data transmission from a network node that is received on a plurality of CCs carrying corresponding symbols as shown in FIG. 4A. The method includes, at 410, receiving a beam switch command from the network node. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 425 the method includes identifying one or more symbols for restricted scheduling in one or more CCs of the plurality of CCs. At 430 the method includes ignoring the one or more symbols identified for restricted scheduling when decoding the data transmission.

FIG. 4C is a flow diagram outlining an example method 450 that may be performed by a network node to transmit a data transmission to a UE on a plurality of CCs carrying corresponding symbols as shown in FIG. 4A. The method includes, at 460, transmitting a beam switch command from to the UE. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 465 the method includes identifying one or more symbols for restricted scheduling in one or more CCs of the plurality of CCs. Candidate symbols for restricted scheduling are shaded in FIG. 4A. At 470 the method includes refraining from scheduling or transmitting data for the UE in the one or more symbols identified for restricted scheduling.

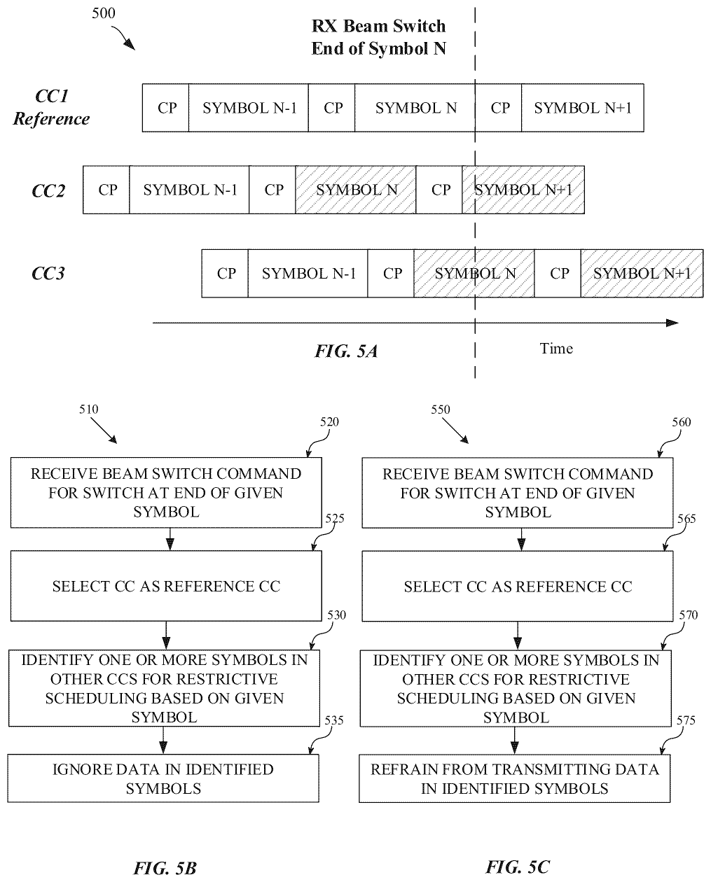

In some instances, one of the CCs will be carrying different or higher priority information (e.g., control information vs data). Measures may be employed to “protect” the symbols in the CC, for example by selecting the CC as the reference CC. FIG. 5A illustrates a data transmission 500 in which CC1 is used as a reference CC. For example, if CC1 transmitted by a PCell or an PSCell, the beam switch will occur at the end of symbol N in CC1. In other examples, a reference CC may be selected by the UE based on some other criteria, for example, based on an order of receipt of the CCs. In the example illustrated in FIG. 5A, when CC1 is selected as the reference signal, the symbols corresponding to symbol N+1 in CC2 and symbol N in CC3 will be received during the RX beam switch and potentially interrupted. It follows that, while not shown in FIG. 5A, if the receiving order of CC2 and CC3 were switched, then the symbol corresponding to symbol N in CC2 and symbol N+1 in CC3 would be interrupted.

In the example illustrated in FIG. 5A, the symbols of the reference CC are protected. This means that none of the symbols in the reference CC are identified for restricted scheduling. To cover the possible orders of reception for the other CCs, the symbols corresponding to symbol N and symbol N+1 in the other CCs (i.e., CC2 and CC3) are identified for restricted scheduling as indicated by the shading. The UE will receive information/data in symbol N and symbol N+1 (as well as other symbols) in the reference CC, CC1. In one example, a CC that is transmitted by a PCell or a PSCell is selected as the reference CC. In this manner, the symbols that may be carrying information in addition to data transmitted by the PCell or PSCell are protected. The other CCs will be carrying data transmitted by secondary cells.

FIG. 5B is a flow diagram outlining an example method 510 that may be performed by a UE to receive a data transmission from a network node that is received on a plurality of CCs carrying corresponding symbols as shown in FIG. 5A. The method includes, at 520, receiving a beam switch command from the network node. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

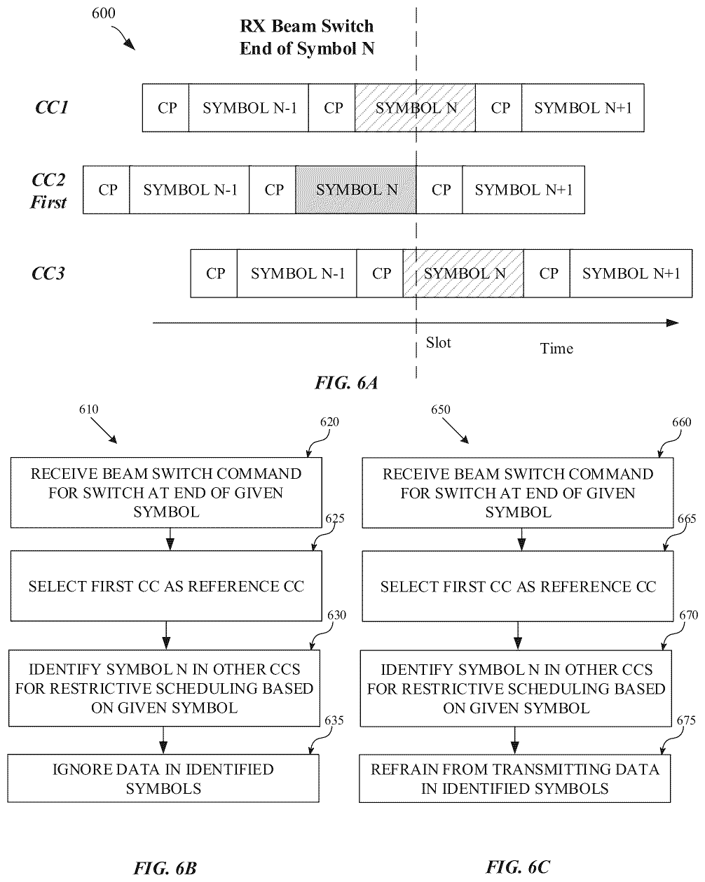

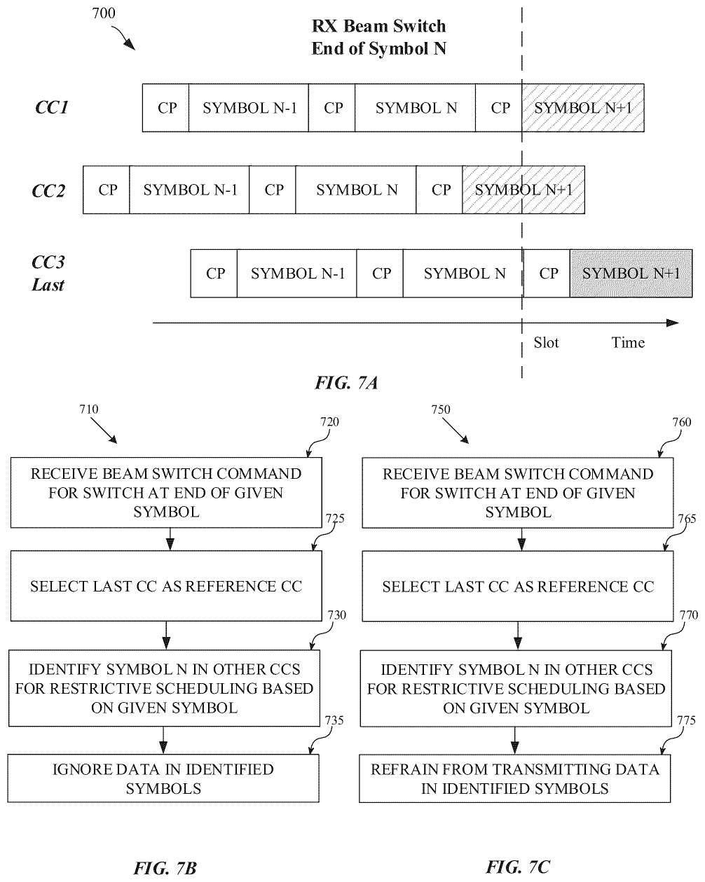

At 525 the method includes selecting one of the plurality of CCs as a reference CC. In one example, if any of the CCs are transmitted by a PCell or a PSCell, then that CC is selected as the reference CC. In another example, the CC of the plurality of CCs in which the given symbol is received first by the UE (referred to herein sometimes as “the first received CC”) is selected as the reference CC as will be described in more detail with reference to FIG. 6. In another example, a CC of the plurality of CCs in which the given symbol is received last by the UE (referred to herein sometimes as “the last received CC”) is selected as the reference CC as will be described in more detail with respect to FIG. 7. At 530 the method includes identifying one or more symbols in the other (non-reference) CCs for restricted scheduling. In the example illustrated in FIG. 5A, symbol N and symbol N+1 in CC2 and CC3 are identified for restricted scheduling.

At 535 the method includes ignoring the one or more symbols identified for restricted scheduling when decoding the data transmission while receiving data in symbols N and N+1 in the reference CC.

FIG. 5C is a flow diagram outlining an example method 550 that may be performed by a network node to transmit a data transmission to a UE on a plurality of CCs carrying corresponding symbols as shown in FIG. 5A. The method includes, at 560, transmitting a beam switch command to the UE. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 565 the method includes selecting one of the plurality of CCs as a reference CC. In one example, if any of the CCs are transmitted by a PCell or a PSCell, then that CC is selected as the reference CC. In another example, the CC of the plurality of CCs in which the given symbol is received first by the UE (referred to herein sometimes as “the first received CC”) is selected as the reference CC. In another example, the CC of the plurality of CCs in which the given symbol is received last by the UE (referred to herein sometimes as “the last received CC”) is selected as the reference CC. At 570 the method includes identifying one or more symbols in the other (non-reference) CCs for restricted scheduling. At 575 the method includes refraining from scheduling or transmitting data in the one or more symbols identified for restricted scheduling while continuing to transmit data in the given symbol and the subsequent symbol in the reference CC.

FIG. 6A illustrates a data transmission in which a first received CC (e.g., CC2 in FIG. 6A) is chosen as a reference CC. The example technique illustrated in FIGS. 6A-6C may be used when none of the CCs carried by the common beam are transmitted by a PCell or a PSCell. It can be seen that when the first received CC is chosen, the symbols corresponding to symbol N in the other CCs (e.g., CC1 and CC3 in FIG. 6A) will be received during the RX beam switch and potentially interrupted. To avoid decoding failure due to interrupted symbols during RX beam switching, the symbols corresponding to symbol N in CC1 and CC3 are identified for restricted scheduling. When symbol N is the last symbol in a slot, the technique outlined in FIG. 6A means that the first symbol in the next slot, symbol N+1 will not be interrupted in any CC. This may be beneficial when a first symbol in a slot carries important information such as reference symbols.

FIG. 6B is a flow diagram outlining an example method 610 that may be performed by a UE to receive a data transmission from a network node that is received on a plurality of CCs carrying corresponding symbols as shown in FIG. 6A. The method includes, at 620, receiving a beam switch command from the network node. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 625 the method includes selecting the CC of the plurality of CCs in which the given symbol is received first by the UE as a reference CC. At 630 the method includes identifying symbols corresponding to symbol N in the other (non-reference) CCs for restricted scheduling. At 635 the method includes ignoring the one or more symbols identified for restricted scheduling when decoding the data transmission while receiving data in symbol N in the reference CC.

FIG. 6C is a flow diagram outlining an example method 650 that may be performed by a network node to transmit a data transmission to a UE on a plurality of CCs carrying corresponding symbols as shown in FIG. 6A. The method includes, at 560, transmitting a beam switch command to the UE. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 665 the method includes selecting the first received CC as a reference CC. At 670 the method includes identifying symbols corresponding to symbol N in the other (non-reference) CCs for restricted scheduling. At 675 the method includes refraining from scheduling or transmitting data in the one or more symbols identified for restricted scheduling while continuing to transmit data in symbols N and N+1 in the reference CC.

It is noted that while the network node is aware of which CCs are transmitted by a PCell or PSCell, the network node may not be aware of the order in which CCs are received by the UE. Thus, when there is no PCell CC or PSCell CC to select as reference CC, the network node may be unable to determine which of the secondary cell CCs are received first by the UE. If this is the case, then one option is to identify symbols corresponding to symbol N in all CCs (e.g., symbol N in CC1, CC2, and CC3) when all of the CCs carried by the common beam are transmitted by secondary cells. In other words, a reference CC is not selected or protected, but rather symbol N (e.g., the last symbol in a slot) in all CCs is subject to restricted scheduling.

FIG. 7A illustrates a data transmission in which a CC of the plurality of CCs in which the given symbol is received last by the UE (e.g., CC3 in FIG. 7A) is chosen as a reference CC. The example technique illustrated in FIGS. 7A-7C may be used when none of the CCs carried by the common beam are transmitted by a PCell or a PSCell. It can be seen that when the last received CC is chosen, the symbols corresponding to symbol N+1 in the other CCs (e.g., CC1 and CC3 in FIG. 7A) will be received during the RX beam switch and potentially interrupted. To avoid decoding failure due to interrupted symbols during RX beam switching, the symbols corresponding to symbol N+1 in CC1 and CC3 are identified for restricted scheduling. When symbol N is the last symbol in a slot, the technique outlined in FIG. 7A means that the last symbol in the beam switching slot, symbol N, will not be interrupted in any CC.

FIG. 7B is a flow diagram outlining an example method 710 that may be performed by a UE to receive a data transmission from a network node that is received on a plurality of CCs carrying corresponding symbols as shown in FIG. 7A. The method includes, at 720, receiving a beam switch command from the network node. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 725 the method includes selecting the last received of the plurality of CCs as a reference CC. At 730 the method includes identifying symbols corresponding to symbol N+1 in the other (non-reference) CCs for restricted scheduling. At 735 the method includes ignoring the one or more symbols identified for restricted scheduling when decoding the data transmission while receiving data in symbol N+1 in the reference CC.

FIG. 7C is a flow diagram outlining an example method 750 that may be performed by a network node to transmit a data transmission to a UE on a plurality of CCs carrying corresponding symbols as shown in FIG. 7A. The method includes, at 760, transmitting a beam switch command to the UE. The beam switch command is configured to cause the UE to switch the UE's RX beam at an end boundary of a given symbol of the data transmission. In some examples, the end boundary of the given symbol is a slot boundary. In some examples, the beam switch command is an indication of a new TCI state or TX beam that is signaled by the network node and causes the UE to switch to a corresponding RX beam.

At 765 the method includes selecting the last received CC as a reference CC. At 770 the method includes identifying symbols corresponding to symbol N+1 in the other (non-reference) CCs for restricted scheduling. At 775 the method includes refraining from scheduling or transmitting data in the one or more symbols identified for restricted scheduling while continuing to transmit data in symbols N+1 in the reference CC.

It is noted that while the network node is aware of which CCs are transmitted by a PCell or PSCell, the network node may not be aware of the order in which CCs are received by the UE. Thus, when there is no PCell CC or PSCell CC to select as reference CC, the network node may be unable to determine which of the secondary cell CCs are received last by the UE. If this is the case, then one option is to identify symbols corresponding to symbol N+1 in all CCs (e.g., symbol N in CC1, CC2, and CC3) when all of the CCs carried by the common beam are transmitted by secondary cells. In other words, a reference CC is not selected or protected, but rather symbol N+1 in all CCs (e.g., the first symbol in a slot) is subject to restricted scheduling.

The UE RX beam switching operations described with reference to FIGS. 3-7 are initiated by a beam switching command transmitted by a network node. In some situations, a UE may autonomously switch its RX beam for different reasons including channel measurements. When the UE RX beam switching is not in response to a TX beam switch (e.g., not synchronized with a network node beam switch), there is no requirement that the beam switch occur at a slot boundary.

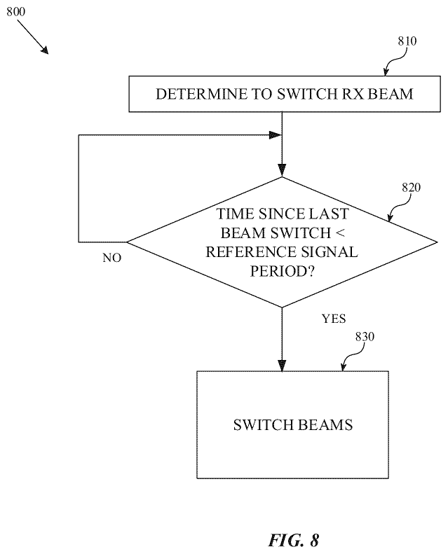

FIG. 8 is a flow diagram outlining a method 800 for autonomous UE RX beam switching. At 810, the UE determines to switch RX beams. The UE may select a boundary of any symbol within a slot for performing the beam switch. At 820, the method includes determining whether at least one period of a selected reference signal (e.g. synchronization signal block (SSB) or channel state information reference signal (CSI-RS)) has elapsed since the last RX beam switch. This is to avoid excessive performance degradation. If it has not been at least one period of the selected reference signal since the last RX beam switch, the method returns to 820 until sufficient time has elapsed. When it has been at least one period of the selected reference signal since the last RX beam switch at 830 the UE performs a beam switch operation to switch RX beams. In this manner at most one slot per reference signal periodicity can be mis-detected for all active CCs. Example reference signals that may be used to time UE RX beam switching include synchronization signal block (SSB) and channel state information (CSI) reference signals.

Included herein are several flow diagrams outlining example methods. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. “Derive” should be construed to encompass computing or calculating the entity or value of the entity based on other quantities or entities. “Derive” should be construed to encompass any manner of deducing or identifying an entity or value of the entity.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

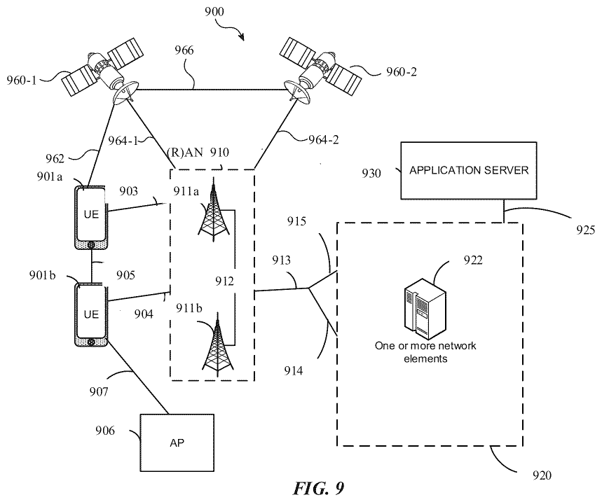

FIG. 9 illustrates an example architecture of a system 900 of a communication network, in accordance with various aspects. The following description is provided for an example system 900 that operates in conjunction with the LTE system standards and 5G or NR system standards as provided by 3GPP technical specifications. However, the example aspects are not limited in this regard and the described aspects may apply to other networks that benefit from the principles described herein, such as future 3GPP systems (e.g., Sixth Generation (6G)) systems, IEEE 702.16 protocols (e.g., WMAN, WiMAX, etc.), or the like.

As shown by FIG. 9, the system 900 includes UE 901a and UE 901b (collectively referred to as “UEs 901” or “UE 901”). In this example, UEs 901 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some aspects, any of the UEs 901 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 901 may be configured to connect, for example, communicatively couple, with a RAN 910. In aspects, the RAN 910 may be an NG RAN or a 5G RAN, an E-UTRAN, or a legacy RAN, such as a UTRAN or GERAN. As used herein, the term “NG RAN” or the like may refer to a RAN 910 that operates in an NR or 5G system 900, and the term “E-UTRAN” or the like may refer to a RAN 910 that operates in an LTE or 4G system 900. The UEs 901 utilize connections (or channels) 903 and 904, respectively, each of which comprises a physical communications interface or layer (discussed in further detail below).

In this example, the connections 903 and 904 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In aspects, the UEs 901 may directly exchange communication data via a ProSe interface 905. The ProSe interface 905 may alternatively be referred to as a SL interface 905 and may comprise one or more logical channels, including but not limited to a PSCCH, a PSSCH, a PSDCH, and a PSBCH.

The UE 901b is shown to be configured to access an AP 906 (also referred to as “WLAN node 906,” “WLAN 906,” “WLAN Termination 906,” “WT 906” or the like) via connection 907. The connection 907 can comprise a local wireless connection, such as a connection consistent with any IEEE 702.11 protocol, wherein the AP 906 would comprise a wireless fidelity (Wi-Fi®) router. In this example, the AP 906 is shown to be connected to the Internet without connecting to the core network of the wireless system (described in further detail below). In various aspects, the UE 901b, RAN 910, and AP 906 may be configured to utilize LWA operation and/or LWIP operation. The LWA operation may involve the UE 901b in RRC_CONNECTED being configured by a RAN node 911a-b to utilize radio resources of LTE and WLAN. LWIP operation may involve the UE 901b using WLAN radio resources (e.g., connection 907) via IPsec protocol tunneling to authenticate and encrypt packets (e.g., IP packets) sent over the connection 907. IPsec tunneling may include encapsulating the entirety of original IP packets and adding a new packet header, thereby protecting the original header of the IP packets.

The RAN 910 can include one or more AN nodes or RAN nodes 911a and 911b (collectively referred to as “RAN nodes 911” or “RAN node 911”) that enable the connections 903 and 904. As used herein, the terms “access node,” “access point,” or the like may describe equipment that provides the radio baseband functions for data and/or voice connectivity between a network and one or more users. These access nodes can be referred to as network nodes, BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As described below, in some implementations, satellites 960 may operate as bases stations (e.g., RAN nodes 911) with respect to UEs 901. As such, references herein to a base station, RAN node 911, etc., may involve implementations where the base station, RAN node 911, etc., is a terrestrial network node and also to implementation where the base station, RAN node 911, etc., is a non-terrestrial network node (e.g., satellite 160).

As used herein, the terms network node, “NG RAN node”, or the like may refer to a RAN node 911 that operates in an NR or 5G system 900 (for example, a gNB), and the term “E-UTRAN node” or the like may refer to a RAN node 911 that operates in an LTE or 4G system 900 (e.g., an eNB). According to various aspects, the RAN nodes 911 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

According to various aspects, the UEs 901 and the RAN nodes 911 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHZ, whereas the unlicensed spectrum may include the 5 GHz band.

To operate in the unlicensed spectrum, the UEs 901 and the RAN nodes 911 may operate using LAA, eLAA, and/or feLAA mechanisms. In these implementations, the UEs 901 and the RAN nodes 911 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 901 RAN nodes 911, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 702.11 technologies. WLAN employs a contention-based channel access mechanism, called CSMA/CA. Here, when a WLAN node (e.g., a mobile station (MS) such as UE 901, AP 906, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 8 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 901 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 901. The PDCCH carries information about the transport format and resource allocations related to the PDSCH channel, among other things. It may also inform the UEs 901 about the transport format, resource allocation, and HARQ information related to the uplink shared channel. Typically, downlink scheduling (assigning control and shared channel resource blocks to the UE 901b within a cell) may be performed at any of the RAN nodes 911 based on channel quality information fed back from any of the UEs 901. The downlink resource assignment information may be sent on the PDCCH used for (e.g., assigned to) each of the UEs 901.

The RAN 910 is shown to be communicatively coupled to a core network-in this aspect, core network (CN) 920. The CN 920 may comprise a plurality of network elements 922, which are configured to offer various data and telecommunications services to customers/subscribers (e.g., users of UEs 901) who are connected to the CN 920 via the RAN 910. The components of the CN 920 may be implemented in one physical node or separate physical nodes including components to read and execute instructions from a machine-readable or computer-readable medium (e.g., a non-transitory machine-readable storage medium). In some aspects, NFV may be utilized to virtualize any or all of the above-described network node functions via executable instructions stored in one or more computer-readable storage mediums (described in further detail below). A logical instantiation of the CN 920 may be referred to as a network slice, and a logical instantiation of a portion of the CN 920 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, example network 900 may include an NTN that may comprise one or more satellites 960-1 and 960-2 (collectively, “satellites 960”). Satellites 960 may be in communication with UEs 901 via service link or wireless interface 962 and/or RAN 910 via feeder links or wireless interfaces 964 (depicted individually as 964-1 and 964). In some implementations, satellite 960 may operate as a passive or transparent network relay node regarding communications between UEs 901 and the terrestrial network (e.g., RAN 910). In some implementations, satellite 960 may operate as an active or regenerative network node such that satellite 960 may operate as a base station to UEs 901 (e.g., as a gNB of RAN 910) regarding communications between UE 901 and RAN 910. In some implementations, satellites 960 may communicate with one another via a direct wireless interface (e.g., 966) or an indirect wireless interface (e.g., via RAN 910 using interfaces 964-1 and 964-2). Additionally, or alternatively, satellite 960 may include a GEO satellite, LEO satellite, or another type of satellite. Satellite 960 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 960 may operate as bases stations (e.g., RAN nodes 911) with respect to UEs 901. As such, references herein to a base station, RAN node 911, etc., may involve implementations where the base station, RAN node 911, etc., is a terrestrial network node and implementation, where the base station, RAN node 911, etc., is a non-terrestrial network node (e.g., satellite 960).

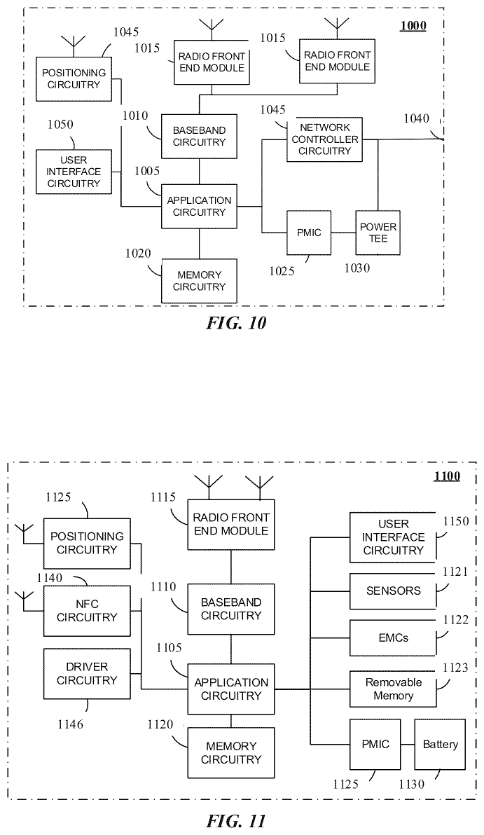

FIG. 10 illustrates an example of infrastructure equipment 1000 in accordance with various aspects. The infrastructure equipment 1000 (or “system 1000”) may be implemented as a network node, base station, radio head, RAN node such as the RAN nodes 911 and/or AP 906 shown and described previously, application server(s) 930, and/or any other element/device discussed herein. In other examples, the system 1000 could be implemented in or by a UE.

The system 1000 includes application circuitry 1005, baseband circuitry 1010, one or more radio front end modules (RFEMs) 1015, memory circuitry 1020, power management integrated circuitry (PMIC) 1025, power tee circuitry 1030, network controller circuitry 1035, network interface connector 1040, satellite positioning circuitry 1045, and user interface 1050. In some aspects, the device 1000 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations.

Application circuitry 1005 includes circuitry such as, but not limited to one or more processors (or processor cores), cache memory, and one or more of low drop-out voltage regulators (LDOs), interrupt controllers, serial interfaces such as SPI, 12C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1005 may be coupled with or may include memory/storage elements and may be configured to execute instructions stored in the memory/storage to enable various applications or operating systems to run on the system 1000. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 1005 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 1005 may comprise, or may be, a special-purpose processor/controller to operate according to the various aspects herein. As examples, the processor(s) of application circuitry 1005 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 1000 may not utilize application circuitry 1005, and instead may include a special-purpose processor/controller to process IP data received from an EPC or 5GC, for example.

User interface circuitry 1050 may include one or more user interfaces designed to enable user interaction with the system 1000 or peripheral component interfaces designed to enable peripheral component interaction with the system 1000. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 10 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 11 illustrates an example of a platform 1100 (or “device 1100”) in accordance with various aspects. In aspects, the computer platform 1100 may be suitable for use as UEs 901, application servers 930, and/or any other element/device discussed herein. The platform 1100 may include any combinations of the components shown in the example. The components of platform 1100 may be implemented as integrated circuits (ICs), portions thereof, discrete electronic devices, or other modules, logic, hardware, software, firmware, or a combination thereof adapted in the computer platform 1100, or as components otherwise incorporated within a chassis of a larger system. The block diagram of FIG. 11 is intended to show a high level view of components of the computer platform 1100. However, some of the components shown may be omitted, additional components may be present, and different arrangement of the components shown may occur in other implementations.

Application circuitry 1105 includes circuitry such as, but not limited to one or more processors (or processor cores), cache memory, and one or more of LDOs, interrupt controllers, serial interfaces such as SPI, 12C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1105 may be coupled with or may include memory/storage elements and may be configured to execute instructions stored in the memory/storage to enable various applications or operating systems to run on the system 1100. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 1105 may include a general or special purpose processor, such as an A-series processor (e.g., the A13 Bionic), available from Apple® Inc., Cupertino, CA or any other such processor. The processors of the application circuitry 1105 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1105 may be a part of a system on a chip (SoC) in which the application circuitry 1105 and other components are formed into a single integrated circuit, or a single package.

The baseband circuitry 1110 may be implemented, for example, as a solder-down substrate including one or more integrated circuits, a single packaged integrated circuit soldered to a main circuit board or a multi-chip module containing two or more integrated circuits.

The platform 1100 may also include interface circuitry (not shown) that is used to connect external devices with the platform 1100. The external devices connected to the platform 1100 via the interface circuitry include sensor circuitry 1121 and electro-mechanical components (EMCs) 1122, as well as removable memory devices coupled to removable memory circuitry 1123.

A battery 1130 may power the platform 1100, although in some examples the platform 1100 may be mounted deployed in a fixed location, and may have a power supply coupled to an electrical grid. The battery 1130 may be a lithium ion battery, a metal-air battery, such as a zinc-air battery, an aluminum-air battery, a lithium-air battery, and the like. In some implementations, such as in V2X applications, the battery 1130 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium using instructions stored in a memory. Many other examples and variations are possible within the scope of the claimed disclosure.

### Examples

Example 1 is a baseband processor for a user equipment (UE), configured to cause the UE to perform operations including receiving a data transmission from a network node, wherein the data transmission is received on a plurality of component carriers (CCs) carrying corresponding symbols on a common beam; receiving a beam switch command from the network node, wherein the beam switch command is configured to cause the UE to switch a receiving (RX) beam at an end boundary of a first symbol of the data transmission; identifying one or more symbols for restricted scheduling in one or more CCs of the plurality of CCs based on the beam switching on the first symbol; and ignoring the one or more symbols identified for restricted scheduling for decoding of the data transmission.
Example 2 includes the subject matter of example 1, including or omitting optional elements, wherein the end boundary of the first symbol corresponds to a slot boundary of the data transmission.
Example 3 includes the subject matter of example 1, including or omitting optional elements, the baseband processor configured to cause the UE to perform operations including selecting a first CC of the plurality of CCs as a reference CC, for the other CCs of the plurality of CCs, identifying one or more symbols based on the first symbol for restricted scheduling based on the beam switching on the first symbol; and decoding the first symbol and a symbol subsequent to the first symbol transmitted in the reference CC for the data transmission.
Example 4 includes the subject matter of example 3, including or omitting optional elements, the baseband processor configured to cause the UE to perform operations including selecting a CC transmitted by a primary cell (PCell) as the reference CC.
Example 5 includes the subject matter of example 3, including or omitting optional elements, the baseband processor configured to cause the UE to perform operations including selecting a CC transmitted by a primary secondary cell (PSCell) as the reference CC.
Example 6 includes the subject matter of example 3, including or omitting optional elements, the baseband processor configured to cause the UE to perform operations including selecting a CC of the plurality of CCs in which the first symbol is received first by the UE as the reference CC.
Example 7 includes the subject matter of example 3, including or omitting optional elements, the baseband processor configured to cause the UE to perform operations including selecting a CC of the plurality of CCs in which the first symbol is received last by the UE as the reference CC.
Example 8 includes the subject matter of example 3, including or omitting optional elements, the baseband processor configured to cause the UE to perform operations including selecting a CC transmitted by a PCell as a reference CC and identifying symbols corresponding to the first symbol and a symbol immediately subsequent the first symbol for restricted scheduling in the other CCs.
Example 9 includes the subject matter of example 3, including or omitting optional elements, the baseband processor configured to cause the UE to perform operations including selecting a CC transmitted by a PSCell as the reference CC and identifying symbols corresponding to the first symbol and a symbol immediately subsequent the first symbol for restricted scheduling in the other CCs.
Example 10 includes the subject matter of example 3, including or omitting optional elements, the baseband processor configured to cause the UE to perform operations including selecting a CC of the plurality of CCs in which the first symbol is received first by the UE as the reference CC and identifying symbols corresponding to the first symbol for restricted scheduling in the other CCs.
Example 11 includes the subject matter of example 3, including or omitting optional elements, the baseband processor configured to cause the UE to perform operations including selecting a CC of the plurality of CCs in which the first symbol is received last by the UE as the reference CC and identifying symbols corresponding to a symbol immediately subsequent the first symbol for restricted scheduling in the other CCs.
Example 12 includes the subject matter of example 1, including or omitting optional elements, the baseband processor configured to cause the UE to perform operations including identifying one or more symbols for restrictive scheduling in all CCs of the plurality of CCs.
Example 13 includes the subject matter of example 1, including or omitting optional elements, the baseband processor configured to cause the UE to perform operations including identifying symbols corresponding to the first symbol for restricted scheduling.
Example 14 includes the subject matter of example 1, including or omitting optional elements, the baseband processor configured to cause the UE to perform operations including identifying symbols corresponding to a symbol immediately subsequent the first symbol for restricted scheduling.
Example 15 includes the subject matter of example 1, including or omitting optional elements, the baseband processor configured to cause the UE to perform operations including identifying symbols corresponding to the first symbol and symbols corresponding to a symbol immediately subsequent the first symbol for restricted scheduling.
Example 16 includes the subject matter of example 1, including or omitting optional elements, the baseband processor configured to cause the UE to perform operations including identifying symbols corresponding to the first symbol for restricted scheduling on all CCs of the plurality of CCs when all CCs of the plurality of CCs are transmitted by secondary cells.
Example 17 includes the subject matter of example 1, including or omitting optional elements, the baseband processor configured to cause the UE to perform operations including identifying symbols corresponding to a symbol immediately subsequent the first symbol for restricted scheduling on all CCs of the plurality of CCs when all CCs of the plurality of CCs are transmitted by secondary cells.
Example 18 is a baseband processor for a network node, configured to cause the network node to perform operations including transmitting a data transmission to a user equipment (UE), wherein the data transmission is transmitted on a plurality of component carriers (CCs) carrying corresponding symbols on a common beam; transmitting a beam switch command to the UE, wherein the beam switch command is configured to cause the UE to switch a receiving (RX) beam at an end boundary of a first symbol of the data transmission; identifying one or more symbols for restricted scheduling in one or more CCs of the plurality of CCs based on the beam switching on the first symbol; and refrain from transmitting data in the one or more symbols identified for restricted scheduling.
Example 19 includes the subject matter of example 18, including or omitting optional elements, wherein the end boundary of the first symbol corresponds to a slot boundary of the data transmission.
Example 20 includes the subject matter of example 18, including or omitting optional elements, the baseband processor configured to cause the network node to perform operations including selecting a first CC of the plurality of CCs as a reference CC, for the other CCs of the plurality of CCs, identifying one or more symbols based on the beam switching on the first symbol for restricted scheduling; and transmitting data in the first symbol and a symbol subsequent to the first symbol transmitted in the reference CC.
Example 21 includes the subject matter of example 20, including or omitting optional elements, the baseband processor configured to cause the network node to perform operations including selecting a CC transmitted by a primary cell (PCell) as the reference CC.
Example 22 includes the subject matter of example 20, including or omitting optional elements, the baseband processor configured to cause the network node to perform operations including selecting a CC transmitted by a primary secondary cell (PSCell) as the reference CC.
Example 23 includes the subject matter of example 20, including or omitting optional elements, the baseband processor configured to cause the network node to perform operations including selecting a CC of the plurality of CCs in which the first symbol is received first by the UE as the reference CC.
Example 24 includes the subject matter of example 20, including or omitting optional elements, the baseband processor configured to cause the network node to perform operations including selecting a CC of the plurality of CCs in which the first symbol is received last by the UE as the reference CC.
Example 25 includes the subject matter of example 20, including or omitting optional elements, the baseband processor configured to cause the network node to perform operations including selecting a CC transmitted by a PCell as a reference CC and identifying symbols corresponding to the first symbol and a symbol immediately subsequent the first symbol for restricted scheduling in the other CCs.
Example 26 includes the subject matter of example 20, including or omitting optional elements, the baseband processor configured to cause the network node to perform operations including selecting a CC transmitted by a PSCell as the reference CC and identifying symbols corresponding to the first symbol and a symbol immediately subsequent the first symbol for restricted scheduling in the other CCs.
Example 27 includes the subject matter of example 20, including or omitting optional elements, the baseband processor configured to cause the network node to perform operations including selecting a CC of the plurality of CCs in which the first symbol is received first by the UE as the reference CC and identifying symbols corresponding to the first symbol for restricted scheduling in the other CCs.
Example 28 includes the subject matter of example 20, including or omitting optional elements, the baseband processor configured to cause the network node to perform operations including selecting a CC of the plurality of CCs in which the first symbol is received last by the UE as the reference CC and identifying symbols corresponding to a symbol immediately subsequent the first symbol for restricted scheduling in the other CCs.
Example 29 includes the subject matter of example 18, including or omitting optional elements, the baseband processor configured to cause the network node to perform operations including identifying one or more symbols for restrictive scheduling in all CCs of the plurality of CCs.
Example 30 includes the subject matter of example 18, including or omitting optional elements, the baseband processor configured to cause the network node to perform operations including identifying symbols corresponding to the first symbol for restricted scheduling.
Example 31 includes the subject matter of example 18, including or omitting optional elements, the baseband processor configured to cause the network node to perform operations including identifying symbols corresponding to a symbol immediately subsequent the first symbol for restricted scheduling.
Example 32 includes the subject matter of example 18, including or omitting optional elements, the baseband processor configured to cause the network node to perform operations including identifying symbols corresponding to the first symbol and symbols corresponding to a symbol immediately subsequent the first symbol for restricted scheduling.
Example 33 includes the subject matter of example 18, including or omitting optional elements, the baseband processor configured to cause the network node to perform operations including identifying symbols corresponding to the first symbol for restricted scheduling on all CCs of the plurality of CCs when all CCs of the plurality of CCs are transmitted by secondary cells.
Example 34 includes the subject matter of example 18, including or omitting optional elements, the baseband processor configured to cause the network node to perform operations including identifying symbols corresponding to a symbol immediately subsequent the first symbol for restricted scheduling on all CCs of the plurality of CCs when all CCs of the plurality of CCs are transmitted by secondary cells.
Example 35 is a baseband processor for a user equipment (UE) configured to cause the UE to perform operations including determining to switch a common receiving (RX) beam at a first symbol boundary; determining whether a period of a selected reference signal has elapsed since a last RX beam switch; and performing a beam switch operation in response to determining that a period of the selected reference signal has elapsed.
Example 36 includes the subject matter of example 35, including or omitting optional elements, wherein the first symbol boundary is not aligned with a slot boundary.
Example 37 includes the subject matter of example 35, including or omitting optional elements, wherein the selected reference signal is a synchronization signal block.
Example 36 includes the subject matter of example 35, including or omitting optional elements, wherein the selected reference signal is a channel state information reference signal.
Example 39 is a method, including receiving a data transmission from a network node, wherein the data transmission is received on a plurality of component carriers (CCs) carrying corresponding symbols on a common beam; receiving a beam switch command from the network node, wherein the beam switch command is configured to cause a UE to switch a receiving (RX) beam at an end boundary of a first symbol of the data transmission; identifying one or more symbols for restricted scheduling in one or more CCs of the plurality of CCs based on the beam switching on the first symbol; and ignoring the one or more symbols identified for restricted scheduling for decoding of the data transmission.
Example 40 includes the subject matter of example 35, including or omitting optional elements, wherein the end boundary of the first symbol corresponds to a slot boundary of the data transmission.
Example 41 includes the subject matter of example 35, including or omitting optional elements, further including selecting a first CC of the plurality of CCs as a reference CC; for the other CCs of the plurality of CCs, identifying one or more symbols based on the first symbol for restricted scheduling based on the beam switching on the first symbol; and decoding the first symbol and a symbol subsequent to the first symbol transmitted in the reference CC for the data transmission.
Example 42 includes the subject matter of example 41, including or omitting optional elements, further including selecting a CC transmitted by a primary cell (PCell) as the reference CC.
Example 43 includes the subject matter of example 41, including or omitting optional elements, further including selecting a CC transmitted by a primary secondary cell (PSCell) as the reference CC.
Example 44 includes the subject matter of example 41, including or omitting optional elements, further including selecting a CC of the plurality of CCs in which the first symbol is received first by the UE as the reference CC.
Example 45 includes the subject matter of example 41, including or omitting optional elements, further including selecting a CC of the plurality of CCs in which the first symbol is received last by the UE as the reference CC.
Example 46 includes the subject matter of example 41, including or omitting optional elements, further including selecting a CC transmitted by a PCell as a reference CC; and identifying symbols corresponding to the first symbol and a symbol immediately subsequent the first symbol for restricted scheduling in the other CCs.
Example 47 includes the subject matter of example 41, including or omitting optional elements, further including selecting a CC transmitted by a PSCell as the reference CC; and identifying symbols corresponding to the first symbol and a symbol immediately subsequent the first symbol for restricted scheduling in the other CCs.
Example 48 includes the subject matter of example 41, including or omitting optional elements, further including selecting a CC of the plurality of CCs in which the first symbol is received first by the UE as the reference CC; and identifying symbols corresponding to the first symbol for restricted scheduling in the other CCs.
Example 49 includes the subject matter of example 41, including or omitting optional elements, further including selecting a CC of the plurality of CCs in which the first symbol is received last by the UE as the reference CC; and identifying symbols corresponding to a symbol immediately subsequent the first symbol for restricted scheduling in the other CCs.
Example 42 includes the subject matter of example 39, including or omitting optional elements, further including identifying one or more symbols for restrictive scheduling in all CCs of the plurality of CCs.
Example 51 includes the subject matter of example 39, including or omitting optional elements, further including identifying symbols corresponding to the first symbol for restricted scheduling.
Example 52 includes the subject matter of example 39, including or omitting optional elements, further including identifying symbols corresponding to a symbol immediately subsequent the first symbol for restricted scheduling.
Example 53 includes the subject matter of example 39, including or omitting optional elements, further including identifying symbols corresponding to the first symbol and symbols corresponding to a symbol immediately subsequent the first symbol for restricted scheduling.
Example 54 includes the subject matter of example 39, including or omitting optional elements, further including identifying symbols corresponding to the first symbol for restricted scheduling on all CCs of the plurality of CCs when all CCs of the plurality of CCs are transmitted by secondary cells.
Example 55 includes the subject matter of example 39, including or omitting optional elements, further including identifying symbols corresponding to a symbol immediately subsequent the first symbol for restricted scheduling on all CCs of the plurality of CCs when all CCs of the plurality of CCs are transmitted by secondary cells.
Example 56 is a method, including: transmitting a data transmission to a user equipment (UE), wherein the data transmission is transmitted on a plurality of component carriers (CCs) carrying corresponding symbols on a common beam; transmitting a beam switch command to the UE, wherein the beam switch command is configured to cause the UE to switch a receiving (RX) beam at an end boundary of a first symbol of the data transmission; identifying one or more symbols for restricted scheduling in one or more CCs of the plurality of CCs based on the beam switching on the first symbol; and refraining from transmitting data in the one or more symbols identified for restricted scheduling.
Example 57 includes the subject matter of example 56, including or omitting optional elements, wherein the end boundary of the first symbol corresponds to a slot boundary of the data transmission.
Example 58 includes the subject matter of example 56, including or omitting optional elements, further including selecting a first CC of the plurality of CCs as a reference CC; for the other CCs of the plurality of CCs, identifying one or more symbols based on the beam switching on the first symbol for restricted scheduling; and transmitting data in the first symbol and a symbol subsequent to the first symbol transmitted in the reference CC.
Example 59 includes the subject matter of example 58, including or omitting optional elements, further including selecting a CC transmitted by a primary cell (PCell) as the reference CC.
Example 60 includes the subject matter of example 58, including or omitting optional elements, further including selecting a CC transmitted by a primary secondary cell (PSCell) as the reference CC.
Example 61 includes the subject matter of example 58, including or omitting optional elements, further including selecting a CC of the plurality of CCs in which the first symbol is received first by the UE as the reference CC.
Example 62 includes the subject matter of example 58, including or omitting optional elements, further including selecting a CC of the plurality of CCs in which the first symbol is received last by the UE as the reference CC.
Example 63 includes the subject matter of example 58, including or omitting optional elements, further including selecting a CC transmitted by a PCell as a reference CC; and identifying symbols corresponding to the first symbol and a symbol immediately subsequent the first symbol for restricted scheduling in the other CCs.
Example 64 includes the subject matter of example 58, including or omitting optional elements, further including selecting a CC transmitted by a PSCell as the reference CC; and identifying symbols corresponding to the first symbol and a symbol immediately subsequent the first symbol for restricted scheduling in the other CCs.
Example 65 includes the subject matter of example 58, including or omitting optional elements, further including selecting a CC of the plurality of CCs in which the first symbol is received first by the UE as the reference CC; and identifying symbols corresponding to the first symbol for restricted scheduling in the other CCs.
Example 66 includes the subject matter of example 58, including or omitting optional elements, further including selecting a CC of the plurality of CCs in which the first symbol is received last by the UE as the reference CC; and identifying symbols corresponding to a symbol immediately subsequent the first symbol for restricted scheduling in the other CCs.
Example 67 includes the subject matter of example 56, including or omitting optional elements, further including identifying one or more symbols for restrictive scheduling in all CCs of the plurality of CCs.
Example 68 includes the subject matter of example 56, including or omitting optional elements, further including identifying symbols corresponding to the first symbol for restricted scheduling.
Example 69 includes the subject matter of example 56, including or omitting optional elements, further including identifying symbols corresponding to a symbol immediately subsequent the first symbol for restricted scheduling.
Example 70 includes the subject matter of example 56, including or omitting optional elements, further including identifying symbols corresponding to the first symbol and symbols corresponding to a symbol immediately subsequent the first symbol for restricted scheduling.
Example 71 includes the subject matter of example 56, including or omitting optional elements, further including identifying symbols corresponding to the first symbol for restricted scheduling on all CCs of the plurality of CCs when all CCs of the plurality of CCs are transmitted by secondary cells.
Example 72 includes the subject matter of example 56, including or omitting optional elements, further including identifying symbols corresponding to a symbol immediately subsequent the first symbol for restricted scheduling on all CCs of the plurality of CCs when all CCs of the plurality of CCs are transmitted by secondary cells.
Example 73 is a method, including: determining to switch a common receiving (RX) beam at a first symbol boundary; determining whether a period of a selected reference signal has elapsed since a last RX beam switch; and performing a beam switch operation in response to determining that a period of the selected reference signal has elapsed.
Example 74 includes the subject matter of example 73, including or omitting optional elements, wherein the first symbol boundary is not aligned with a slot boundary.
Example 75 includes the subject matter of example 73, including or omitting optional elements, wherein the selected reference signal is a synchronization signal block.
Example 76 includes the subject matter of example 73, including or omitting optional elements, wherein the selected reference signal is a channel state information reference signal.

A method as substantially described herein with reference to each or any combination substantially described herein, comprised in examples 1-76, and in the Detailed Description.

A non-transitory computer readable medium as substantially described herein with reference to each or any combination substantially described herein, comprised in examples 1-76, and in the Detailed Description.

A wireless device configured to perform any action or combination of actions as substantially described herein, comprised in examples 1-76, and in the Detailed Description.

An integrated circuit configured to perform any action or combination of actions as substantially described herein, comprised in examples 1-76, and in the Detailed Description.

An apparatus configured to perform any action or combination of actions as substantially described herein, comprised in examples 1-76, and in the Detailed Description.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-38. (canceled)

39. A baseband processor, coupled to a memory, configured to:
receive a data transmission from a network node, wherein the data transmission is received on a plurality of component carriers (CCs) carrying corresponding symbols on a common beam;
receive a beam switch command from the network node, wherein the beam switch command is configured to cause a UE to switch a receiving (RX) beam at an end boundary of a first symbol of the data transmission;
identify one or more symbols for restricted scheduling in one or more CCs of the plurality of CCs based on the beam switching on the first symbol; and
ignore the one or more symbols identified for restricted scheduling for decoding of the data transmission.

40. The baseband processor of claim 39, wherein the end boundary of the first symbol corresponds to a slot boundary of the data transmission.

41. The baseband processor of claim 39, further configured to identify one or more symbols for restricted scheduling in all CCs of the plurality of CCs.

42. The baseband processor of claim 39, further configured to identify symbols corresponding to the first symbol for restricted scheduling.

43. The baseband processor of claim 39, further configured to identify symbols corresponding to a symbol immediately subsequent the first symbol for restricted scheduling.

44. The baseband processor of claim 39, further configured to identify symbols corresponding to the first symbol and symbols corresponding to a symbol immediately subsequent the first symbol for restricted scheduling.

45. The baseband processor of claim 39, further configured to identify symbols corresponding to the first symbol for restricted scheduling on all CCs of the plurality of CCs when all CCs of the plurality of CCs are transmitted by secondary cells.

46. The baseband processor of claim 39, further configured to identify symbols corresponding to a symbol immediately subsequent the first symbol for restricted scheduling on all CCs of the plurality of CCs when all CCs of the plurality of CCs are transmitted by secondary cells.

47. A user equipment (UE), comprising:
a radio front end module, configured to
receive a data transmission from a network node, wherein the data transmission is received on a plurality of component carriers (CCs) carrying corresponding symbols on a common beam;
receive a beam switch command from the network node, wherein the beam switch command is configured to cause a UE to switch a receiving (RX) beam at an end boundary of a first symbol of the data transmission; and
baseband circuitry coupled to the radio front end module, configured to
select a first CC of the plurality of CCs as a reference CC;
for the other CCs of the plurality of CCs, identify one or more symbols based on the first symbol for restricted scheduling based on the beam switching on the first symbol;
decode the first symbol and a symbol subsequent to the first symbol transmitted in the reference CC for the data transmission; and
ignore the one or more symbols identified for restricted scheduling for decoding of the data transmission.

48. The UE of claim 47, wherein the baseband circuitry is configured to select a CC transmitted by a primary cell (PCell) as the reference CC.

49. The UE of claim 47, wherein the baseband circuitry is configured to select a CC transmitted by a primary secondary cell (PSCell) as the reference CC.

50. The UE of claim 47, wherein the baseband circuitry is configured to select a CC of the plurality of CCs in which the first symbol is received first by the UE as the reference CC.

51. The UE of claim 47, wherein the baseband circuitry is configured to select a CC of the plurality of CCs in which the first symbol is received last by the UE as the reference CC.

52. The UE of claim 47, wherein the baseband circuitry is configured to select a CC transmitted by a PCell as a reference CC; and
identify symbols corresponding to the first symbol and a symbol immediately subsequent the first symbol for restricted scheduling in the other CCs.

53. The UE of claim 47, wherein the baseband circuitry is configured to
select a CC transmitted by a PSCell as the reference CC; and
identify symbols corresponding to the first symbol and a symbol immediately subsequent the first symbol for restricted scheduling in the other CCs.

54. The UE of claim 47, wherein the baseband circuitry is configured to select
a CC of the plurality of CCs in which the first symbol is received first by the UE as the reference CC; and
identify symbols corresponding to the first symbol for restricted scheduling in the other CCs.

55. The UE of claim 47, wherein the baseband circuitry is configured to
select a CC of the plurality of CCs in which the first symbol is received last by the UE as the reference CC; and
identify symbols corresponding to a symbol immediately subsequent the first symbol for restricted scheduling in the other CCs.

56. A baseband processor, coupled to a memory, configured to:
determine to switch a common receiving (RX) beam at a first symbol boundary;
determine whether a period of a selected reference signal has elapsed since a last RX beam switch; and
perform a beam switch operation in response to determining that a period of the selected reference signal has elapsed.

57. The baseband processor of claim 56, wherein the first symbol boundary is not aligned with a slot boundary.

58. The baseband processor of claim 56, wherein the selected reference signal is a synchronization signal block or a channel state information reference signal.
